(19) United States
(12) Patent Application Publication
(10) Pub. No.: US 2026/0001748 A1
(43) Pub. Date: Jan. 1, 2026

(54) CRANE AND METHOD FOR ASSEMBLING AND DISASSEMBLING CRANE

(71) Applicant: KOBELCO CONSTRUCTION MACHINERY CO., LTD., Hiroshima-shi (JP)

(72) Inventors: Koji SUMIMOTO, Hyogo (JP); Teppei MAEDO, Hyogo (JP)

(73) Assignee: KOBELCO CONSTRUCTION MACHINERY CO., LTD., Hiroshima-shi (JP)

(21) Appl. No.: 18/881,555

(22) PCT Filed: Jul. 6, 2023
(86) PCT No.: PCT/JP2023/025119

§ 371 Date: Jan. 6, 2025

(30) Foreign Application Priority Data
Jul. 21, 2022 (JP) 2022-116100

(51) Int. Cl. B66C 23/82; B66C 23/66

(52) U.S. Cl. CPC B66C 23/82; B66C 23/66; B66C 2700/0321

(57) ABSTRACT

Provided are a crane capable of improving the workability for lowering and raising a strut, and a method for assembling and disassembling the crane. The crane includes a boom including a boom distal end part, a jib including a jib proximal end part, a strut connected to the boom distal end part or the jib proximal end part and raisable and lowerable by vertically rotationally movement about a strut rotation center; a winch, a winch rope wound and delivered by the winch; and a strut support unit attached to the jib back surface or the strut front surface. The strut support unit supports the strut in a fallen posture at a raisable position above the jib in a boom-and-jib fallen state. In the raisable position, a rope connection part to which the rope is connected in the strut is higher than the strut rotation center.

### TECHNICAL FIELD

The present invention relates to a crane and a method for assembling and disassembling a crane.

### BACKGROUND ART

Patent Literature 1 discloses a method for assembling a crane. The method includes: connecting a main hoisting rope, which is a winch rope, to a suspension lug of a jib mast, which is a strut; and towing the suspension lug by winding the main hoisting rope by a winch mounted on the machine body to thereby raise the strut from a fallen posture, thereby eliminating the need for preparing an auxiliary crane different from the crane in order to raise the jib mast.

The method further includes changing the towing direction in which the suspension lug is towed through the hoisting rope into a raising direction. The raising direction is a direction in which the towing force acts on the jib mast effectively as a moment for turning the jib mast.

The method requires work for placing the main hoisting rope on a guide sheave provided on the tip of the boom in order to change the towing direction, the work being bothersome. For example, the case where the main hoisting rope as the winch rope is wound around the drum of the winch over a plurality of rows aligned widthwise of the drum involves a specific intersection angle between the main hoisting rope and the center axis of the boom, which generates the need for the widthwise alignment of the main hoisting rope with the groove of the guide sheave. It is not easy to perform such alignment at a high place on the boom with poor scaffolding.

### CITATION LIST

### Patent Literature

Patent Literature 1: Japanese Unexamined Patent Publication No. 2011-190084

### SUMMARY OF INVENTION

It is an object of the present invention to provide a crane and a method for assembling and disassembling a crane, which allow the workability of raising a fallen strut and falling down a raised strut to be improved.

Provided is a crane comprising a crane body, a boom, a jib, a strut, a winch, a winch rope and a strut support unit. The boom includes a boom proximal end part connected to the crane body so as to allow the boom to be raised and lowered with respect to the crane body, and a boom distal end part opposite to the boom proximal end part. The jib includes a jib proximal end part to be connected to the boom distal end part so as to allow the jib to be raised and lowered with respect to the boom. The strut includes a strut proximal end part and a rope connection part. The strut proximal end part is connected to the boom distal end part or the jib proximal end part capably of vertically rotational movement around a strut rotation center so as to allow the strut to be shifted between a fallen posture in which the strut has been fallen onto the jib and a raised posture in which the strut has been raised from the jib in a boom-and-jib fallen state where each of the boom and the jib has been fallen down. The rope connection part is located above the strut proximal end part in the raised posture of the strut. The winch is fixed to the crane body or the boom and capable of performing a winding motion and a delivery motion. The winch rope is wound around the winch by the winding motion and delivered from the winch by the delivery motion. The winch rope includes a rope tip part capable of being detachably connected to the rope connection part of the strut, allowing the winding motion of the winch to make a towing force act on the rope connection part of the strut toward the winch with the rope tip part connected to the rope connection part. The strut support unit is attachable to and detachable from a jib back surface of the jib or a strut front surface of the strut, the jib back surface being a surface to face upward in the boom-and-jib fallen state, the strut front surface being a surface to be opposed to the jib back surface in the fallen posture. The strut support unit has a support height dimension that allows the strut support unit to support the strut at a raisable position in a state where the strut support unit is attached to the jib back surface or the strut front surface and interposed between the strut front surface of the strut in the fallen posture and the jib back surface. The raisable position is a position where the rope connection part of the strut is higher than the strut rotation center, and the support height dimension is a vertical dimension from a position where the strut support unit contacts the jib back surface to a position where the strut support unit contacts the strut front surface.

### BRIEF DESCRIPTION OF DRAWINGS

FIG. 1 is a side view of a crane according to the disclosed embodiment, showing a state where a boom has been raised.

FIG. 2 is a side view of the crane, showing a boom-and-jib fallen state where the boom and the jib connected thereto have been fallen onto the ground.

FIG. 3 is a plan view of a strut distal end part of a strut of the crane in the boom-and-jib fallen state.

FIG. 4 is a side view of the boom distal end part of the boom and the vicinity thereof.

FIG. 5 is a side view of the crane, where the strut is in a fallen posture in the boom-and-jib fallen state.

FIG. 6 is a view where the part enclosed by the enclosing line VI in FIG. 5 is enlarged.

FIG. 7 is a perspective view showing the jib in the boom-and-jib fallen state, the strut in the fallen posture, and a strut support unit attached to the strut.

FIG. 8 is a side view showing a modification of the strut support unit, which is in a use state.

FIG. 9 is a side view of the strut support unit shown in FIG. 8, the strut support unit being in a storage state.

### DESCRIPTION OF EMBODIMENTS

Hereinafter will be described a preferred embodiment of the present invention with reference to the drawings.

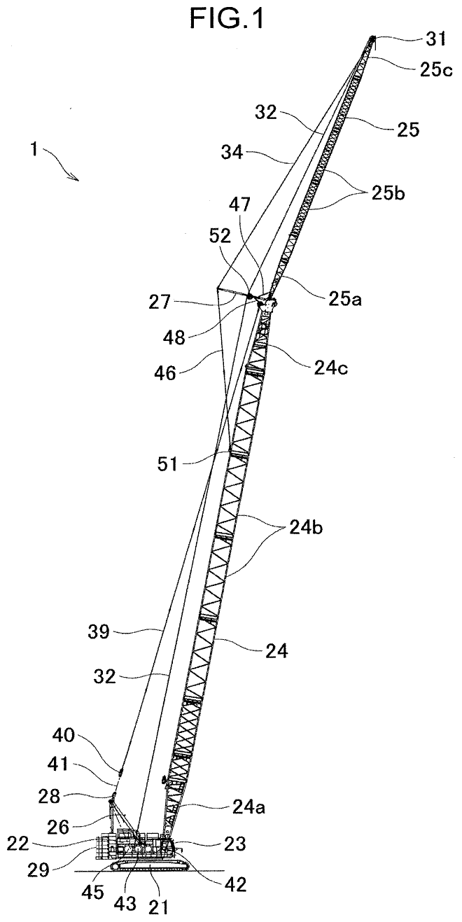

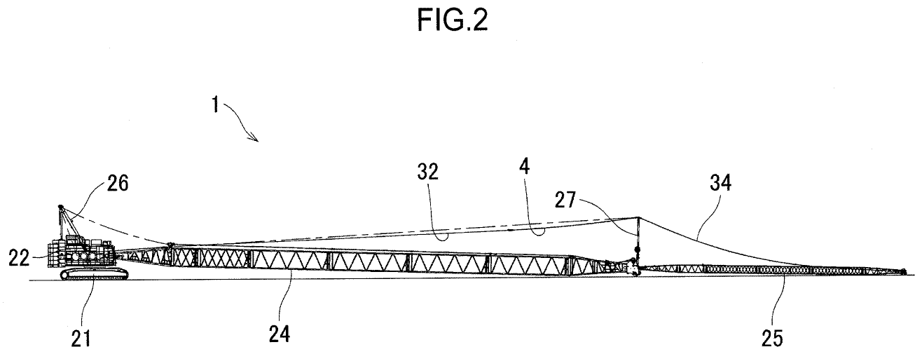

FIGS. 1 and 2 show a crane 1 according to the embodiment. The crane 1 includes a crane body, which includes a lower traveling body 21 and an upper turning body 22 mounted on the lower traveling body 21 capably of turning. The lower traveling body 21 includes a lower frame and a traveling means, which includes a pair of crawlers. The crane 1 may be either a mobile crane including a moving means different from the pair of crawlers, e.g., a plurality of wheels, or a fixed crane with no traveling means. The present invention can be applied to also, for example, a tower crane or a luffing crane.

The upper turning body 22 includes a turning frame 22a, an operation chamber 23, and a counter weight 29. The turning frame 22a is a base substantially parallel to the traveling surface of the lower traveling body 21, connected to the lower frame of the lower traveling body 21 capably of turning. The operation chamber 23 and the counter weight 29 are mounted on the front and rear parts of the turning frame 22a, respectively.

The crane 1 further includes a plurality of elements supported by the turning frame 22a, the plurality of elements including a boom 24, a jib 25, a gantry 26, a strut 27, a lower spreader 28, a hoisting rope 32, an upper spreader 40, a boom derricking rope 41, a hoisting winch 43, a boom derricking winch 45, a jib backstop device 47 and a strut backstop device 48.

The boom 24 is connected (attached) to the front part of the turning frame 22a of the upper turning body 22 derrick ably with respect to the upper turning body 22. Specifically, as shown in FIG. 1, the boom 24 includes a lower boom 24a, at least one intermediate boom 24b, and an upper boom 24c, and FIG. 1 shows a state where the boom 24 has been raised. The lower boom 24a includes a proximal end part and a distal end part on the side opposite thereto. The proximal end part forms a boom proximal end part connected to the turning frame 22a capably of vertically rotational movement. The at least one intermediate boom 24b is interposed between the lower boom 24a and the upper boom 24c so as to interconnect the distal end part of the lower boom 24a and the upper boom 24c. The upper boom 24c includes a distal end part that is the end part on the side opposite to the lower boom 24a and the at least one intermediate boom 24b, the distal end part forming a boom distal end part. The boom distal end part is the end part on the side opposite to the boom proximal end part out of the opposite end parts of the boom 24. To the boom distal end part is connectable a boom guyline 39. Specifically, the boom guyline 39 includes a boom connection end part to be connected to the boom distal end part and a spreader connection end part on the side opposite to the boom connection end part.

The jib 25 includes a jib proximal end part and a jib distal end part on the side opposite to the jib proximal end part, and the jib proximal end part is connected (attached) to the boom distal end part of the boom 24, that is, the distal end part of the upper boom 24c in the present embodiment, so as to allow the jib 25 to be derricked with respect to the boom 24. The jib 25 illustrated in FIG. 1 includes a lower jib 25a, at least one intermediate jib 25b, and an upper jib 25c. The lower jib 25a includes a proximal end part and a distal end part on the side opposite to the proximal end part, the proximal end part forming the jib proximal end part to be connected to the boom distal end part capably of vertically rotational movement. The at least one intermediate jib 25b is interposed between the distal end part of the lower jib 25a and the upper jib 25c to interconnect the distal end part of the lower jib 25a and the upper jib 25c. The upper jib 25c includes a distal end part that is the end part opposite to the lower jib 25a and the at least one intermediate jib 25b, the distal end part forming a jib distal end part. The jib distal end part is the end part on the side opposite to the jib proximal end part out of the opposite end parts of the jib 25. To the jib distal end part of the jib 25 is rotatably attached a jib point sheave 31, from which a non-illustrated hook device is suspended through the hoisting rope 32.

The gantry 26 is fixed to the rear part of the turning frame 22a and supports the boom distal end part of the boom 24. The crane according to the present invention may be one including a mast in place of the gantry 26.

The strut 27 includes a strut proximal end part and a strut distal end part opposite to the strut proximal end part, and the strut proximal end part is connected to the jib proximal end part of the jib 25 (the proximal end part of the lower jib 25a in the present embodiment) capably of vertically rotational movement around respective center axes of a pair of strut rotation shafts 270 described below in detail so as to allow the strut 27 to be derricked with respect to the jib 25. The center axis of each of the strut rotation shafts 270 corresponds to a strut rotation center, around which the strut 27 is capable of vertically rotational movement with respect to the jib 25 (specifically, the lower jib 25a). The strut proximal end part of the strut 27, alternatively, may be connected to the boom distal end part of the boom 24 (the distal end part of the upper boom 24c in the present embodiment) capably of vertically rotational movement.

The strut distal end part of the strut 27 and the jib distal end part of the jib 25 are interconnected through a jib guyline 34. The strut distal end part of the strut 27 and a guyline connection part 51 included in the boom 24 are interconnected through a pair of strut guylines 46. Each of the strut guylines 46 has opposite end parts, one of the opposite end parts being a boom connection end part detachably connected to the guyline connection part 51, the other being a strut connection end part.

To the central part of the strut 27 is rotatably attached a sheave 52. On the sheave 52 is placed the hoisting rope 32.

The lower spreader 28 and the upper spreader 40 constitute a boom derricking device in association with the boom derricking rope 41 and the boom derricking winch 45. The lower spreader 28 is attached to the upper end of the gantry 26, and the upper spreader 40 is connected to the spreader connection end part of the boom guyline 39. The boom derricking rope 41 is stretched between the lower spreader 28 and the upper spreader 40.

The hoisting winch 43 and the boom derricking winch 45 are fixed to a central part of the turning frame 22a. The hoisting winch 43 includes a hoisting winch drum, around which the hoisting rope 32 is wound. The hoisting winch 43 is an example of a winch according to the present invention, and the hoisting rope 32 is an example of a winch rope according to the present invention, the hoisting rope 32 having a rope tip part to be connected to the strut 27 as described later. The boom derricking winch 45 includes a boom derricking winch drum, around which the boom derricking rope 41 is wound. The hoisting winch 43 may be fixed to the boom proximal end of the boom 24 or a part in the vicinity thereof (i.e., the lower boom 24a in the present embodiment). Alternatively, the boom derricking winch 45 may be fixed to a lower part of the gantry 26.

The hoisting winch 43 is capable of performing a winding motion of winding the hoisting rope 32 and a delivery motion of delivering the hoisting rope 32, through respective rotations of the hoisting winch drum in opposite directions, and the hoisting motion and the delivery motion performing hoisting and lowering the hook device, respectively. The boom derricking winch 45 is capable of performing a winding motion of winding the boom derricking rope 41 and a delivery motion of delivering the boom derricking rope 41, through respective rotations of the boom derricking winch drum in opposite directions, and the winding motion and the delivery motion derricks the boom 24, specifically, brings the boom 24 into vertically rotational movement around a horizontal boom foot pin 42 which is the fulcrum of the boom 24.

The jib backstop device 47 is provided on a lower part in the jib back surface of the jib 25. The jib backstop device 47 comes to be received by a non-illustrated backstop receiver provided in the strut 27 accompanying the rotational movement of the jib 25 in the direction in which the jib 25 is raised, that is, moved toward the strut 27, with respect to the boom 24, thereby preventing the jib 25 from excessive rotational movement in the raised direction.

The strut backstop device 48 is provided in a lower part of a strut back surface of the strut 27. The strut back surface is a surface opposite to the strut front surface, that is, a surface facing the opposite side to the jib 25. The strut backstop device 48 comes to be received by a non-illustrated backstop receiver provided in the boom 24 accompanying the rotational movement of the strut 27 with respect to the boom 24 and the jib 25 in the direction in which the strut 27 is raised, that is, moved toward the boom 24, thereby preventing the strut 27 from excessive rotational movement in the raised direction.

The disassembly and assembly of the thus configured crane 1 are performed in a boom-and-jib fallen state where both the boom 24 and the jib 25 have been fallen onto the ground as shown in FIG. 2.

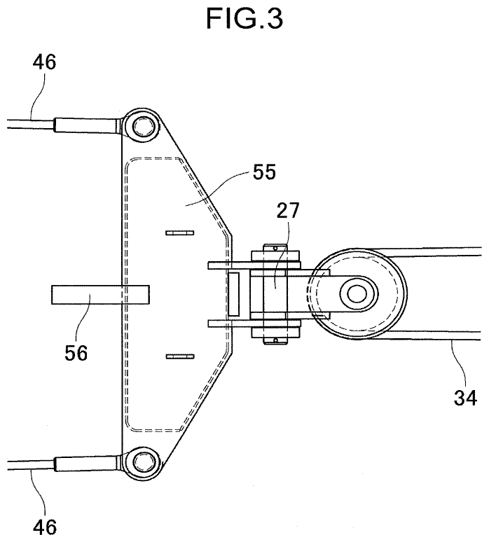

The strut 27 includes, in addition to a strut body with the strut proximal end part and the strut distal end, a guyline connection member 55 and a rope connection member 56 shown in FIG. 3. FIG. 3 is a plan view showing the boom-and-jib fallon state.

The guyline connection member 55 is interposed between the strut distal end part and the pair of strut guylines 46. Specifically, in a boom width direction, which is the width direction of the boom 24 (vertical direction in FIG. 3), the guyline connection member 55 includes an intermediate part connected to the strut distal end part and opposite end parts located on opposite outer sides of the intermediate part, to which end parts respective strut connection end parts of the pair of strut guylines 46 are connected, respectively.

The rope connection member 56, which corresponds to a rope connection part of the strut 27, is fixed to a central part of the guyline connection member 55 in the boom width direction. In the present embodiment, thus, in order to derrick the strut 27 in the boom-and-jib fallen state, the rope tip part of the hoisting rope 32 is connected to the rope connection member 56, which is the rope connection part. More specifically, the crane 1 according to the present embodiment further includes a string-shaped member 4, through which the rope tip part of the hoisting rope 32 and the rope connection member 56 are interconnected.

In the strut 27, the part to which the rope tip part of the hoisting rope 32 is to be connected (the part to be connected through the string-shaped member 4 in the present embodiment), namely, the rope connection part, is not limited to the rope connection member 56. For example, the rope connection part may be a longitudinally intermediate part of the strut 27, that is, a part between the strut proximal end part and the strut distal end part.

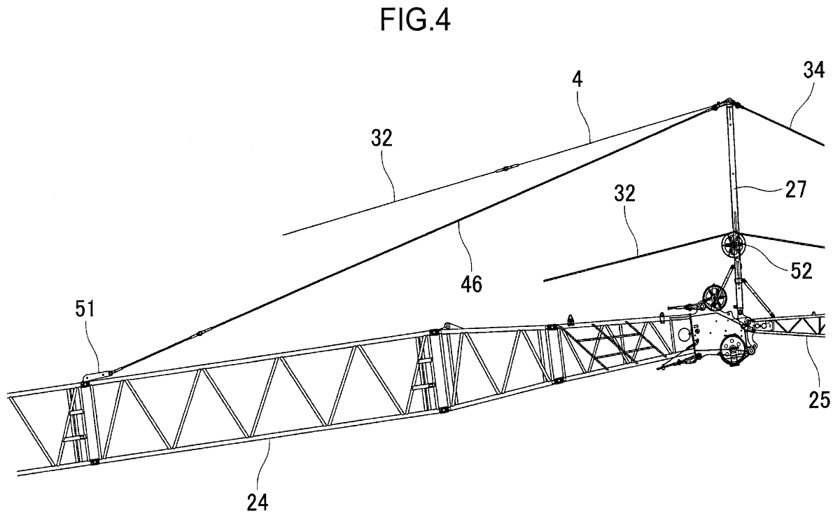

FIG. 4 is a side view showing the boom distal end part of the boom 24 and the vicinity thereof; as shown in FIG. 4, the string-shaped member 4 is interposed between the strut 27 and the hoisting rope 32 to interconnect them. Specifically, the string-shaped member 4 includes a strut connection end part to be connected to the rope connection part (the rope connection member 56 in the present embodiment) of the strut 27 and a rope connection end part, which is the end part on the side opposite thereto, and the rope connection end part is detachably connected to the rope tip part of the hoisting rope 32. The string-shaped member 4 only has to be a member that has flexibility and is stretchable in an arbitrary direction. The string-shaped member 4 illustrated in FIG. 4 is a sling, but may be either a rope or a wire. When the hoisting rope 32 and the strut 27 are not interconnected through the string-shaped member 4, that is, when the use of the string-shaped member 4 is absent, the rope connection end part of the string-shaped member 4 is connected to a non-illustrated connective retention part provided in the strut 27.

The connection of the strut connection end part of the string-shaped member 4 to the rope connection part of the strut 27 (the rope connection member 56) allows the rope connection end part of the string-shaped member 4 to be connected to the hoisting rope 32 at a position lower than the connection position at which the hoisting rope 32 would be directly connected to the strut 27. This enables the workability of the interconnection of the strut 27 and the hoisting rope 32 to be improved.

In the boom-and-jib fallen state shown in FIG. 2, performed for the disassembly of the crane 1 is the work of shifting the strut 27 from the raised posture shown in FIG. 2 to the fallen posture. The raised posture is a posture in which the strut 27 has been raised so as to extend upward from the strut proximal end part, and the fallen posture is a posture in which the strut 27 has been fallen onto the jib back surface of the jib 25 in the boom-and-jib derricking state. The work of falling down the strut 27 includes connecting the hoisting rope 32 to the rope connection member 56 through the string-shaped member 4, releasing the connection between the strut guyline 46 and the guyline connection part 51, and the delivery motion performed by the hoisting winch 43 to deliver the hoisting rope 32. The delivery motion causes the strut 27 to be fallen by the self-weight of the strut 27 from the raised posture to the fallen posture on the jib 25.

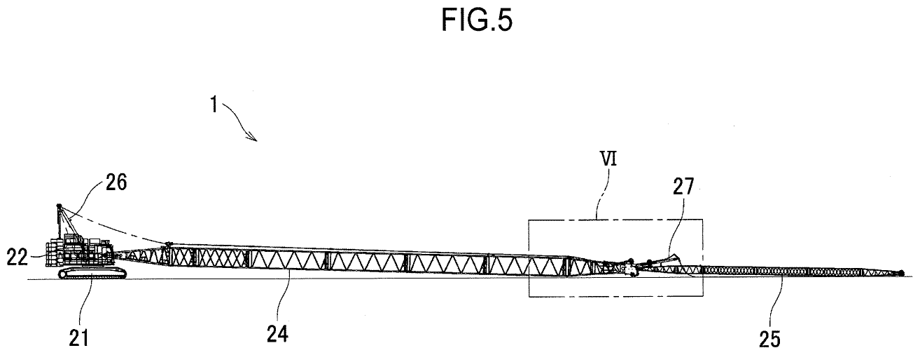

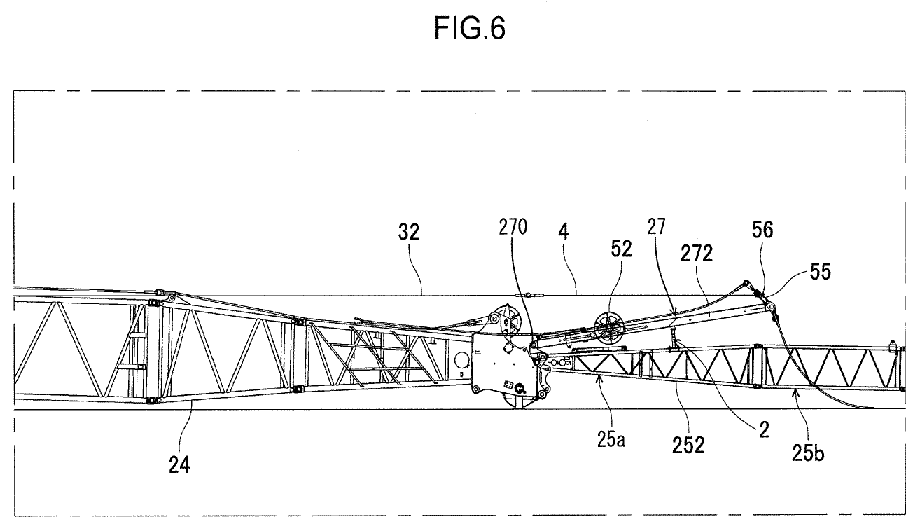

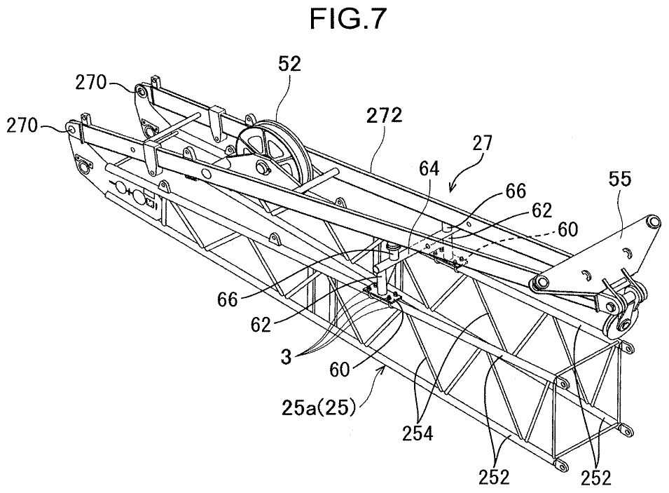

FIG. 5 is a side view showing the state where the strut 27 has been shifted to the fallen posture in the boom-and-jib fallen posture; FIG. 6 is a view in which the part enclosed by the enclosing line VI in FIG. 5 is enlarged; FIG. 7 is a perspective view of the jib 25 in the boom-and-jib fallen state and the strut 27 having been fallen thereon. The crane 1 further includes a strut support unit 2 shown in FIGS. 5 to 7, and the strut support unit 2 is detachably attached to the jib back surface of the jib 25. The strut support unit 2, alternatively, may be attached to the strut front surface of the strut 27.

As shown in FIG. 6, the strut support unit 2 is interposed vertically between the strut front surface of the strut 27 in the fallen posture and the jib back surface of the jib 25. In other words, the strut 27 in the fallen posture is supported on the jib 25 through the strut support unit 2. The strut support unit 2 has a support height dimension that allows the strut support unit 2 to support the strut 27 in the fallen posture at a raisable position. The raisable position is a position at which the strut 27 is supported by the strut support unit 2 so as to render the rope connection part of the strut 27 (that is, the rope connection member 56 which is the part to which the strut connection end part of the string-shaped member 4 connected to the hoisting rope 32 is connected in the present embodiment) higher than the strut rotation center (i.e., the center axes of the pair of strut rotation shafts 270 in the present embodiment). The support height dimension of the strut support unit 2 is the vertical dimension from the position at which the strut support unit 2 contacts the jib back surface (the position of the bottom surface of the strut support unit 2 in FIG. 7) to the position at which the strut support unit 2 contacts the strut front surface (the position of the upper end of the strut support unit 2 in FIG. 7). The support height dimension of the strut support unit 2, therefore, is large enough to allow the strut support unit 2 interposed between the jib back surface and the strut front surface to support the rope connection part at a position higher than the strut rotation center (i.e., the center axes of the pair of strut rotation shafts 270 in the present embodiment).

Moreover, as shown in FIGS. 6 and 7, the support height dimension of the strut support unit 2 is large enough to prevent the sheave 52 attached to the strut 27 from interfering with the jib 25. In other words, the raised height position provided by the support height dimension further has a height enough to prevent the sheave 52 and the jib 25 from interfering with each other, with respect to the jib 25. Thus preventing the sheave 52 attached to the strut 27 in the fallen posture from interfering with the jib 25 enables at least one of the sheave 52 and the jib 25 to be prevented from being damaged.

After the shift of the strut 27 to the fallen posture, the connection between the hoisting rope 32 and the rope connection member 56 is released. Specifically, in the present embodiment, the connection between the hoisting rope 32 and the rope connection end part of the string-shaped member 4 is released. Thereafter, the upper jib 25c and the intermediate jib 25b are removed sequentially in this order, and further the lower jib 25a and the strut 27 are integrally removed from the boom 24.

On the other hand, in the assembly of the crane 1, the lower jib 25a and the strut 27 are integrally attached to the boom 24. Next, the intermediate jib 25b and the upper jib 25c are attached to the lower jib 25a sequentially in this order, the jib 25 thus being assembled. Thereafter, the rope tip part of the hoisting rope 32 is connected to the rope connection end part of the string-shaped member 4 with the strut connection end part of the string-shaped member 4 having already been connected to the rope connection member 56, whereby the rope tip part is connected to the rope connection member 56 which is the rope connection part. In this state, the hoisting winch 43 performs the winding motion of winding up the hoisting rope 32, thereby raising the strut 27 from the fallen posture to the raised posture.

As shown in FIG. 6, in a state where the strut 27 is supported on the jib 25 in the fallen posture through the strut support unit 2, the rope connection part of the strut 27, namely, the rope connection member 56 which is the part to which the strut connection end part of the string-shaped member 4 is connected, is held at a position higher than the strut proximal end part of the strut 27. This enables the towing force applied to the strut 27 through the hoisting rope 32 by the winding motion of the hoisting winch 43 to form a moment having a direction to raise the strut 27 from the fallen posture to the raised posture. The strut 27 in the fallen posture, therefore, can be raised suitably by utilization of the hoisting winch 43 and the hoisting rope 32 with no conventional use of any guide sheave for changing the direction of the towing force. Conversely, by the delivery motion of delivering the hoisting rope 32 performed by the hoisting winch 43, the strut 27 can be quietly (safely) fallen from the raised posture to the fallen posture on the jib 25 with constant application of tension to the hoisting rope 32.

Next will be described details of the strut support unit 2 in the present embodiment and the peripheral part thereof with reference to FIG. 7.

The jib 25 has a lattice structure. Specifically, the part to which the strut support unit 2 is to be attached in the jib 25 (that is, the lower jib 25a in the present embodiment) includes a plurality of (four in the example shown in FIG. 7) main members 252 extending in the longitudinal direction of the lower jib 25a, and a plurality of diagonal members 254, each of which interconnects the main members 252 adjacent to each other among the plurality of main members 252. Among the plurality of main members 252, the pair of left and right main members 252 located on the upper side in the boom-and-jib fallen state shown in FIG. 7 form the jib back surface.

On the other hand, the strut 27 includes a pair of left and right main members 272 extending in the longitudinal direction of the strut 27, the pair of main members 272 including respective proximal end parts (left end parts in FIGS. 6 and 7), which form the strut proximal end parts to be connected to the respective proximal end parts (left end parts in FIGS. 6 and 7) of the pair of left and right main members 252 of the lower jib 25a through the strut rotation shafts 270 capably of vertically rotational movement around the center axes of the pair of strut rotation shafts 270 (strut rotation center). On the other hand, to respective distal end parts of the pair of left and right main members 272 (right end parts in FIG. 6 and FIG. 7) are connected the guyline connection member 55. Besides, the sheave 52 is rotatably supported by the pair of main members 272 between the pair of main members 272.

The strut support unit 2 shown in FIG. 7 includes a pair of bottom plates 60, a pair of leg parts 62, a beam part 64 and a pair of reception parts 66. The pair of bottom plates 60 are detachably fixed to respective back surfaces of the pair of main members 252, the back surfaces forming the jib back surface (the upper surface in the boom-and-jib fallen state). The pair of leg parts 62 extend upward from the pair of bottom plates 60 in the boom-and-jib fallen state. The beam part 64 extends across the jib 25 (the lower jib 25a in the present embodiment) in the width direction thereof, connected to the upper ends of the pair of leg parts 62, respectively. The pair of reception parts 66 protrude upward beyond the beam part 64 and receive the strut front surface of the strut 27 fallen down to the fallen posture (respective lower surfaces of the pair of main members 272 in the present embodiment) to thereby support the strut 27 at the raisable position. The raisable position is a position at which the strut 27 is supported so as to render the rope connection part of the strut 27 (the rope connection member 56 which is the part to which the strut connection end part of the string-shaped member 4 connected to the hoisting rope 32 is connected, in the present embodiment) higher than the strut rotation center (the center axes of the pair of strut rotation shafts 270 in the present embodiment).

The crane 1 further includes a plurality of fastening tools 3 shown in FIG. 7. The plurality of fastening tools 3 fasten the part to contact the jib back surface in the strut support unit 2, i.e., the pair of bottom plates 60 in the present embodiment, to the jib 25, thereby enabling the strut support unit 2 to be detachably attached to the jib 25. The fastening tool 3 is, for example, a combination of a U-bolt and a nut. The fastening tool 3 eliminates the need for welding work for fixing the strut support unit 2 to the jib 25, allowing the strut support unit 2 to be easily attached to the crane 1. Besides, removing the strut support unit 2 from the jib 25 when the crane 1 is disassembled and transported enable respective heights of the lower jib 25a and the strut 27 included in the object of the transport to be reduced, for example, to be restrained under the transport limit height.

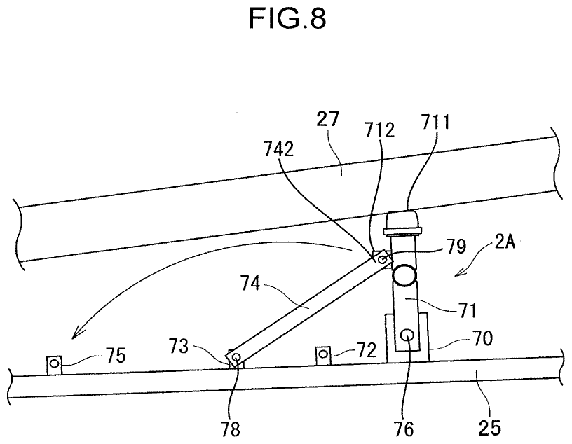

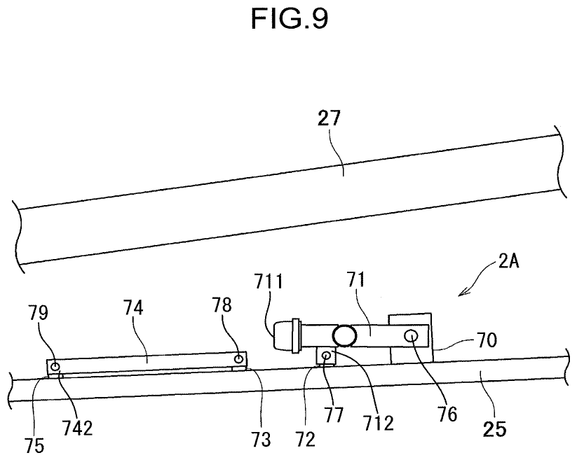

Although the strut support unit 2 always keeps a constant posture when attached to the lower jib 25a of the jib 25, the strut support unit according to the present invention may have plural postures. The example thereof is shown in FIGS. 8 and 9.

FIGS. 8 and 9 show a strut support unit 2A that can be used in place of the strut support unit 2, the strut support unit 2A being shiftable between the support state shown in FIG. 8 and the storage state shown in FIG. 9. As shown in FIG. 8, in the support state, at least a part of the strut support unit 2A can be raised with respect to the jib back surface of the jib 25 to come into contact with the strut front surface of the strut 27 in the fallen posture, in the boom-and-jib fallen state, to thereby support the strut 27 at the raised height position with respect to the jib back surface. As shown in FIG. 9, in the storage state, the entire strut support unit 2A is fallen to be laid along the jib back surface of the jib 25 to thereby reduce the transport height of the combination of the jib 25 (the lower jib 25a in the embodiment) and the strut 27 connected thereto.

The strut support unit 2A includes a first base part 70, a strut support member 71, a first holding part 72, a second base part 73, a raised-state keeping member 74, and a second holding part 75. Each of the first base part 70 and the second base part 73 is fixed to the jib back surface so as to protrude upward from the jib back surface (upper surface in FIG. 8 and FIG. 9) of the jib 25.

The strut support member 71 is connected to the first base part 70 through a horizontal pin 76 to be capable of vertically rotational movement around the pin 76, thereby being switchable between a raised posture shown in FIG. 8 and a fallen posture shown in FIG. 9. The strut support member 71 in the raised posture has been raised with respect to the jib back surface of the jib 25 to allow the upper end 711 of the strut support member 71 to contact the strut front surface (the lower surface in FIG. 8 and FIG. 9) of the strut 27 in the fallen posture, thereby supporting the strut 27 at the raisable position. On the other hand, the strut support member 71 in the fallen posture has been fallen to be laid along the jib back surface, and the strut support member 71 is held in the fallen posture by the connection of a pin connection part 712 provided in the strut support member 71 to the first holding part 72 through a pin 77. The strut support member 71 can be constituted by, for example, the same members as the pair of leg parts 62, the beam part 64, and the pair of reception parts 66 according to the above embodiment. In this case, it is preferable to provide the first base part 70 and the holding part 72 for the pair of leg parts 62 and the pair of reception parts 66, respectively.

The raised-state keeping member 74 is connected to the second base part 73 through a horizontal pin 78 to be capable of vertically rotational movement around the pin 78, thereby allowed to be switched between a raised-state keeping posture shown in FIG. 8 and the fallen posture shown in FIG. 9. In the raised-state keeping member 74 in the raised-state keeping posture, the distal end part 742 of the raised-state keeping member 74 is connectable to the pin connection part 712 of the strut support member 71 through a pin 79, whereby the raised-state keeping member 74 holds the strut support member 71 in the raised posture while the raised-state keeping member 74 is in a posture oblique to the jib back surface. The raised-state keeping member 74 in the fallen posture has been fallen to be laid along the jib back surface in the same direction as the strut support member 71 in the fallen posture, and the raised-state keeping member 74 is held in the fallen posture by the connection of the distal end part 742 to the second holding part 75 through the pin 79 (or another pin).

Thus, in the support state shown in FIG. 8, the raised-state keeping member 74 in the raised-state keeping posture holds the strut support member 71 in the raised posture, and the upper end 711 of the strut support member 71 contacts the strut front surface (lower surface in FIG. 8) of the fallen strut 27, which enables the strut support unit 2 to support the strut 27 at the raisable position, which is the position where the rope connection part of the strut 27 (the rope connection member 56 which is the part to which the strut connection end part of the string-shaped member 4 is connected) is higher than the strut rotation center of the strut 27. On the other hand, in the storage state, both the strut support member 71 and the raised-state keeping member 74 are held in respective fallen postures, which enables the strut support unit 2A to render the height of the combination of the lower jib 25a and the strut 27, the combination being the transport object, smaller than that in the support state, for example, to suppress the height under a transport limit height, when the crane 1 is disassembled and transported.

The crane according to the present invention is applicable to also one comprising a plurality of struts, for example, comprising a front strut and a rear strut, such as a tower crane or a luffing crane. For example, interposing a strut support unit similar to the strut support unit 2 between the strut front surface of the front strut and the jib back surface of the jib or between the strut back surface of the front strut and the strut front surface of the rear strut allows the rope connection part (the part to which the guyline connection end part of the string-shaped member 4 or the rope tip part of the hoisting rope 32 according to the embodiment is connected) in the front strut in the fallen posture or the rear strut in the fallen posture to be kept higher than the strut rotation center of the front strut or the rear strut, thereby enabling the front strut or the rear strut to be efficiently raised to a raised posture by use of the towing force of the rope generated by the winch winding motion.

The crane 1 according to the embodiment can be disassembled, for example, as follows. The following explanation is made about a step for falling the boom 24 and the jib 25 having been raised as shown in FIG. 1 and disassembling the jib 25.

In the crane 1, the boom derricking winch 45 delivers the boom derricking rope 41 shown in FIG. 1 to thereby make the boom 24 fallen onto the ground by the own weight. Before or after the landing of the tip of the jib 25, the jib backstop device 47 is removed from the non-illustrated backstop receiver provided in the strut 27, and shifted to a posture along the jib 25. Thereafter, the further fall of the boom 24 involves the upward rotational movement, that is, the rotational movement in the direction to approach the strut 27, of the jib 25, reducing the tension in the jib guyline 34 interconnecting the jib 25 and the strut 27.

The boom 24 is further fallen down, thereby bringing the boom 24 and the jib 25 into the boom-and-jib fallen state where both the boom 24 and the jib 25 have been fallen onto the ground as shown in FIG. 2. In the boom-and-jib fallen state, the strut backstop device 48 is removed from the backstop receiver provided in the boom 24, and shifted to a posture along the strut 27. On the other hand, through the string-shaped member 4, the rope tip part of the hoisting rope 32 is connected to the rope connection member 56 provided in the central part of the guyline connection member 55 as shown in FIG. 3. At this stage, if the strut support unit 2A shown in FIGS. 8 and 9 is used in place of the strut support unit 2 shown in FIG. 7, the strut support unit 2A should be shifted from the storage state shown in FIG. 9 to the support state shown in FIG. 8.

Next, the connection between the guyline connection part 51 of the boom 24 and the strut guyline 46 is released, and thereafter the hoisting rope 32 is delivered from the hoisting winch 43, whereby the strut 27 is fallen down from the raised posture to be shifted to the fallen posture shown in FIG. 5. In the fallen posture, the strut 27 is supported on the jib back surface of the jib 25 through the strut support unit 2 (or the strut support unit 2A in the support state).

Until the arrival of the strut 27 at the fallen posture, that is, until the arrival of the strut 27 at the raisable position at which the strut 27 is supported by the strut support unit 2, the rope connection part of the strut 27 (the part to which the rope tip part of the hoisting rope 32 is connected through the string-shaped member 4, namely, the rope connection member 56) is constantly kept higher than the strut rotation center of the strut 27 as shown in FIG. 6, which enables the strut 27 to be quietly fallen down to the fallen posture, in spite of use of the own weight of the strut 27, with constant application of tension in the hoisting rope 32. Thus, the strut 27 can be restrained from being vigorously fallen by gravity due to the decrease in the tension caused by the loosening of the hoisting rope 32, thereby being prevented from being damaged.

After the arrival of the strut 27 at the raisable position where the strut 27 is supported on the jib back surface of the jib 25 through the strut support unit 2, the connection between the rope connection part of the string-shaped member 4 and the hoisting rope 32 is released, and the rope connection part is connected to the non-illustrated connective retention part provided in the strut 27. Then, the upper jib 25c and the intermediate jib 25b are removed sequentially in this order from the lower jib 25a of the jib 25, and further the lower jib 25a and the strut 27 are integrally removed from the boom 24.

On the other hand, the crane 1 can be assembled as follows. The following explanation is made about the step for connecting the jib 25 to the boom 24 in the boom-and-jib fallen state shown in FIG. 2 and raising the boom 24 and the jib 25.

First, as shown in FIG. 6, to the boom 24 having been fallen on the ground is connected the lower jib 25a to which the strut 27 has been already connected. At this time, the strut 27 is in the fallen posture and supported on the jib back surface of the lower jib 25a through the strut support unit 2. In this state, the intermediate jib 25b and the upper jib 25c are assembled sequentially in this order to the lower jib 25a.

Next, the connection between the connective retention part provided in the strut 27 and the strut connection end part of the string-shaped member 4 is released, and the rope tip part of the hoisting rope 32 is connected to the strut connection end part. In this state, the winding motion of winding the hoisting rope 32 by the hoisting winch 43 is started.

At the start of the winding motion, as shown in FIG. 6, the strut 27 is supported at the raised height position by the strut support unit 2, and the rope connection part (the rope connection member 56 which is the part to which the guyline connection end part of the string-shaped member 4 is connected in the present embodiment) in the strut 27 is held at a position higher than the rotation center of the strut 27, which enables the towing force applied to the hoisting rope 32 by the winding motion to form a moment that rotates the strut 27 around the strut rotation center in a direction to raise the strut 27 from the fallen posture toward the raised posture (counterclockwise moment in FIGS. 6 and 7). This allows the strut 27 in the fallen posture to be raised to the raised posture by use of the hoisting winch 43 and the hoisting rope 32 with no conventional use of any guide sheave for changing the direction of the rope.

After the arrival of the strut 27 at the raised posture shown in FIG. 2, the guyline connection part 51 of the boom 24 and the boom connection end part of the strut guyline 46 are interconnected. On the other hand, the jib backstop device 47 is received by the non-illustrated backstop receiver provided in the strut 27, and the strut backstop device 48 is received by the non-illustrated backstop receiver provided in the boom 24. In the case where the strut support unit 2A shown in FIGS. 8 and 9 is used, the strut support unit 2A is shifted from the support state shown in FIG. 8 to the storage state shown in FIG. 9.

Next, the connection between the rope connection end part of the string-shaped member 4 and the rope tip part of the hoisting rope 32 is released, and the rope tip part is connected to the connective retention part of the strut 27. Then, the boom derricking winch 45 winds the boom derricking rope 41, whereby the boom 24 is raised as shown in FIG. 1.

As has been described, there is provided a crane and a method for assembling and disassembling a crane, which allow the workability of raising a fallen strut and falling down a raised strut to be improved.

Provided is a crane comprising a crane body, a boom, a jib, a strut, a winch, a winch rope and a strut support unit. The boom includes a boom proximal end part connected to the crane body so as to allow the boom to be raised and lowered with respect to the crane body, and a boom distal end part opposite to the boom proximal end part. The jib includes a jib proximal end part to be connected to the boom distal end part so as to allow the jib to be raised and lowered with respect to the boom. The strut includes a strut proximal end part and a rope connection part. The strut proximal end part is connected to the boom distal end part or the jib proximal end part capably of vertically rotational movement around a strut rotation center so as to allow the strut to be shifted between a fallen posture in which the strut has been fallen onto the jib and a raised posture in which the strut has been raised from the jib in a boom-and-jib fallen state where each of the boom and the jib has been fallen down. The rope connection part is located above the strut proximal end part in the raised posture of the strut. The winch is fixed to the crane body or the boom and capable of performing a winding motion and a delivery motion. The winch rope is wound around the winch by the winding motion and delivered from the winch by the delivery motion. The winch rope includes a rope tip part capable of being detachably connected to the rope connection part of the strut, allowing the winding motion of the winch to make a towing force act on the rope connection part of the strut toward the winch with the rope tip part connected to the rope connection part. The strut support unit is attachable to and detachable from a jib back surface of the jib or a strut front surface of the strut, the jib back surface being a surface to face upward in the boom-and-jib fallen state, the strut front surface being a surface to be opposed to the jib back surface in the fallen posture. The strut support unit has a support height dimension that allows the strut support unit to support the strut at a raisable position in a state where the strut support unit is attached to the jib back surface or the strut front surface and interposed between the strut front surface of the strut in the fallen posture and the jib back surface. The raisable position is a position where the rope connection part of the strut is higher than the strut rotation center, and the support height dimension is a vertical dimension from a position where the strut support unit contacts the jib back surface to a position where the strut support unit contacts the strut front surface.

In the boom-and-jib fallen state of the crane, the strut support unit supports the strut in the fallen posture at the raisable position where the rope connection part of the strut is higher than the strut rotation center, thereby enabling the towing force of the rope acting on the rope connection part of the strut in the fallen posture to form a moment around the strut rotation center in a direction to raise the strut from the fallen posture toward the raised posture. This enables the strut in the fallen posture to be raised by use of the winch and the winch rope with no conventional use of any guide sheave for changing the direction of the winch rope, and enables the strut to be quietly fallen from the raised posture to the fallen posture with constant application of a tension to the winch rope. Thus allowed to be improved the workability of raising the strut in the fallen posture and falling down the strut in the raised posture.

The crane preferably further comprises a fastening tool that detachably fastens the strut support unit to the jib or the strut. The use of the fastening tool eliminates the need for a welding work for fixing the strut support unit to the jib or the strut to thereby allow the strut support unit to be easily attached to the jib or the strut. Besides, the strut support unit is allowed to be removed from the jib or the strut when the crane is disassembled and transported, which makes it possible to lower the assembly of at least a part of the jib (the lower jib 25a in the above-described embodiment) and the strut, which are the transport object, for example, to prevent the height of the assembly from exceeding the transport limit height.

The strut support unit, preferably, is switchable between a support state and a storage state. In the support state, at least a part of the strut support unit is raised with respect to the jib back surface or the strut front surface and supports the strut at the raisable position, thereby holding the rope connection part of the strut at a position higher than the strut rotation center to enable the strut to be raised by the towing force of the winch rope. On the other hand, in the storage state, the entire strut support unit is fallen to be laid along the jib back surface or the strut front surface, thereby allowing the height of the entire transport object including the jib and the strut fallen thereon to be smaller than that in the support state.

Preferably, the crane further comprises a string-shaped member to be interposed between the rope connection part of the strut and the rope tip part to interconnect the rope connection part and the rope tip part. The string-shaped member is a member having flexibility and being stretchable in an arbitrary direction, including a strut connection end part to be detachably connected to the rope connection part and a rope connection end part to be detachably connected to the rope tip part. The advanced connection of the strut connection end part to the rope connection part of the strut allows the rope connection end part of the string-shaped member and the rope tip part to be interconnected at a lower position than the rope connection part of the strut, specifically, allows the rope connection end part and the rope tip part to be interconnected at a lower position than that in the case where the rope tip part is directly connected to the rope connection part of the strut, that is, allows the rope tip part to be connected to the rope connection part through the string-shaped member. This allows the workability of the interconnection of the rope connection part of the strut and the rope tip part to be improved.

In the case of the crane further comprising a sheave attached to the strut, it is preferable that the raisable position has a height, with respect to the jib back surface, enough to prevent the sheave attached to the strut from interfering with the jib. This prevents the sheave and the jib from interfering with each other with no addition of any special device, thereby allowing at least one of the sheave and the jib to be prevented from being damaged by the interference.

It is preferable that the strut proximal end part is connected to the jib proximal end part and the jib and the strut are configured to be integrally attachable to and detachable from the boom while the jib proximal end part and the strut proximal end part are kept interconnected in the boom-and-jib fallen state and in a state where the strut is supported at the raisable position by the strut support unit. Thus integrally attaching the jib and the strut to the boom and integrally detaching the jib and the strut from the boom while keeping a state where the jib proximal end part and the strut proximal part are interconnected and the strut support unit supports the strut allows the workability of assembly and disassembly of the crane to be further improved.

Also provided is a method for assembling and disassembling the crane. The method includes: a step of attaching the strut support unit to the jib back surface or the strut front surface; a step of making the winch perform the delivery motion in the boom-and-jib fallen state to thereby fall the strut in the raised posture to the raisable position at which the strut is supported by the strut support unit; and making the winch perform the winding motion in the boom-and-jib fallen state to thereby raise the strut in the fallen posture supported at the raisable position by the strut support unit to the raised posture.

Although the embodiment of the present invention has been described, shown is merely a specific example, not intended to limit the present invention, and the specific configuration or the like is allowed to be appropriately modified. Besides, the action and effect described in the embodiment of the invention are merely enumerated the most suitable action and effect generated from the present invention, and the action and effect according to the present invention are not limited to those described in the embodiments of the present invention.

1. A crane comprising:
a crane body;
a boom including a boom proximal end part and a boom distal end part opposite to the boom proximal end part, the boom proximal end part connected to the crane body so as to allow the boom to be raised and lowered with respect to the crane body;
a jib including a jib proximal end part to be connected to the boom distal end part so as to allow the jib to be raised and lowered with respect to the boom;
a strut including a strut proximal end part and a rope connection part, the strut proximal end part connected to the boom distal end part or the jib proximal end part capably of vertically rotational movement around a strut rotation center so as to allow the strut to be shifted between a fallen posture in which the strut has been fallen onto the jib and a raised posture in which the strut has been raised from the jib in a boom-and-jib fallen state where each of the boom and the jib has been fallen down, the rope connection part located above the strut proximal end part in the raised posture of the strut;
a winch fixed to the crane body or the boom, the winch being capable of performing a winding motion and a delivery motion;
a winch rope to be wound around the winch by the winding motion and to be delivered from the winch by the delivery motion, the winch rope including a rope tip part capable of being detachably connected to the rope connection part of the strut to allow the winding motion of the winch to make a towing force act on the rope connection part of the strut toward the winch with the rope tip part connected to the rope connection part;
a strut support unit attachable to and detachable from a jib back surface of the jib or a strut front surface of the strut, the jib back surface being an upper surface of the jib in the boom-and-jib fallen state, the strut front surface being a surface to be opposed to the jib back surface in the fallen posture, wherein
the strut support unit has a support height dimension that allows the strut support unit to support the strut at a raisable position in a state where the strut support unit is attached to the jib back surface or the strut front surface and interposed between the strut front surface of the strut in the fallen posture and the jib back surface, the raisable position being a position where the rope connection part of the strut is higher than the strut rotation center, the support height dimension being a vertical dimension from a position where the strut support unit contacts the jib back surface to a position where the strut support unit contacts the strut front surface.

2. The crane according to claim 1, further comprising a fastening tool that detachably fastens the strut support unit to the jib or the strut.

3. The crane according to claim 1, wherein: the strut support unit is switchable between a support state and a storage state; in the support state, at least a part of the strut support unit has been raised with respect to the jib back surface or the strut front surface to support the strut at the raisable position; in the storage state, the entire strut support unit has been fallen to be laid along the jib back surface or the strut front surface.

4. The crane according to claim 1, further comprising a string-shaped member to be interposed between the rope connection part of the strut and the rope tip part to interconnect the rope connection part and the rope tip part, wherein the string-shaped member has a strut connection end part to be detachably connected to the rope connection part and a rope connection end part to be detachably connected to the rope tip part.

5. The crane according to claim 1, further comprising a sheave attached to the strut, wherein the raisable position has a height, with respect to the jib back surface, enough to prevent the sheave attached to the strut from interfering with the jib.

6. The crane according to claim 1, wherein the strut proximal end part is connected to the jib proximal end part, and the jib and the strut are integrally attachable to and detachable from the boom while the jib proximal end part and the strut proximal end part are kept interconnected in the boom-and-jib fallen state and in a state where the strut is supported at the raisable position by the strut support unit.

7. A method for assembling and disassembling a crane according to claim 1, the method comprising:
a step of attaching the strut support unit to the jib back surface or the strut front surface;
a step of making the winch perform the delivery motion in the boom-and-jib fallen state to thereby fall the strut in the raised posture to the raisable position at which the strut is supported by the strut support unit; and
making the winch perform the winding motion in the boom-and-jib fallen state to thereby raise the strut in the fallen posture supported at the raisable position by the strut support unit to the raised posture.
